(19) United States
(12) Patent Application Publication
(10) Pub. No.: US 2015/0371239 A1
(43) Pub. Date: Dec. 24, 2015

(54) PATH ANALYSIS OF NEGATIVE INTERACTIONS

(71) Applicant: Google Inc., Mountain View, CA (US)

(72) Inventor: Neil Hoyne, Santa Clara, CA (US)

(73) Assignee: Google Inc., Mountain View, CA (US)

(21) Appl. No.: 14/254,651

(22) Filed: Apr. 16, 2014

(51) Int. Cl. G06Q 30/02

(52) U.S. Cl. CPC G06Q 30/0201

(57) ABSTRACT

Systems, methods, and computer-readable storage media that may be used to evaluate impact of negative interactions on revenue are provided. One method includes receiving path data representing a plurality of paths and identifying one or more negative interactions within one or more of the paths ending in an interaction other than a conversion. Each negative interaction includes one of one or more types of interactions that decrease a likelihood of a path resulting in a conversion. The method further includes, for each of the one or more negative interactions, determining an estimated probability that the one or more paths including the negative interaction would have resulted in a conversion if the one or more paths excluded the negative interaction. The method further includes estimating an amount of lost revenue associated with one or more of the negative interactions based on the estimated probability.

### BACKGROUND

Content providers often publish content items in networked resources through online content management systems with the goal of having an end user interact with (e.g., click through) the content items and perform a converting action, such as providing information of value to the content providers and/or purchasing a product or service offered by the content providers. However, the types of interactions users have with resources associated with a content provider can impact the likelihood they will perform the desired converting action. For instance, if a user is presented with a well-organized sales webpage, the user desires the product, and the product is in stock, the user may purchase the product through the webpage. Conversely, if the sales webpage is confusing, or if the product is out of stock, the user may navigate away from the webpage and may purchase the product through a different provider, or may purchase a different product. It is difficult for content providers to evaluate the impact such negative interactions may have on the revenue of the content provider.

### SUMMARY

One illustrative implementation of the disclosure relates to a method that includes receiving, at a computerized analysis system, path data representing a plurality of paths. Each path includes one or more interactions of a user with one or more resources. The method further includes identifying, by the analysis system, one or more negative interactions within one or more of the plurality of paths ending in an interaction other than a conversion. Each negative interaction includes one of one or more types of interactions that decrease a likelihood of a path resulting in a conversion. Each negative interaction is included within one or more of the plurality of paths. The method further includes, for each of the one or more negative interactions, determining, by the analysis system, an estimated probability that the one or more paths including the negative interaction would have resulted in a conversion if the one or more paths excluded the negative interaction based on a first set of two or more of the plurality of paths including one or more common characteristics with the path including the negative interaction. The method further includes estimating an amount of lost revenue associated with one or more of the negative interactions based on the estimated probability.

Another implementation relates to a system including at least one computing device operably coupled to at least one memory. The at least one computing device is configured to receive path data representing a plurality of paths. Each path includes one or more interactions of a user with one or more resources. The at least one computing device is further configured to identify one or more negative interactions within one or more of the plurality of paths ending in an interaction other than a conversion. Each negative interaction includes one of one or more types of interactions that decrease a likelihood of a path resulting in a conversion. Each negative interaction is included within one or more of the plurality of paths. The at least one computing device is further configured to, for each of the one or more negative interactions, determine an estimated probability that the one or more paths including the negative interaction would have resulted in a conversion if the one or more paths excluded the negative interaction based on a first set of two or more of the plurality of paths including one or more common characteristics with the path including the negative interaction. The at least one computing device is further configured to estimate an amount of lost revenue associated with one or more of the negative interactions based on the estimated probability.

Yet another implementation relates to one or more computer-readable storage media having instructions stored thereon that, when executed by at least one processor, cause the at least one processor to perform operations. The operations include receiving path data representing a plurality of paths. Each path includes one or more interactions of a user with one or more resources. The operations further include identifying one or more negative interactions within one or more of the plurality of paths ending in an interaction other than a conversion. Each negative interaction includes one of one or more types of interactions that decrease a likelihood of a path resulting in a conversion. Each negative interaction is included within one or more of the plurality of paths. The operations further include, for each of the one or more negative interactions, determining an estimated probability that the one or more paths including the negative interaction would have resulted in a conversion if the one or more paths excluded the negative interaction based on a first set of two or more of the plurality of paths including one or more common characteristics with the path including the negative interaction. The operations further include estimating an amount of lost revenue associated with one or more of the negative interactions based on the estimated probability. The operations further include determining at least one of an estimated amount of conversions or an estimated cost per conversion if the plurality of paths excluded the one or more of the negative interactions based on the estimated probability.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for analyzing negative interactions in path data and estimating lost revenue due to the negative interactions according to an illustrative implementation.

FIG. 3 is an illustration of a user interface configured to provide information pertaining to analyzed negative interactions according to an illustrative implementation.

FIG. 4 is a block diagram of a detailed implementation of an analysis system according to an illustrative implementation.

FIG. 5 is a block diagram of a computing system according to an illustrative implementation.

### DETAILED DESCRIPTION

Referring generally to the Figures, various illustrative systems and methods are provided that may be used to estimate costs associated with lost opportunities resulting from negative interactions of a user along the path to conversion. Performance for a content provider marketing digital content is largely a function of the quality of traffic that is driven to resources of the content provider, and the ability of the resources to convert that traffic into profitable customers. While there often is substantial focus on improving the quality of traffic directed to the resources, content providers often devote little effort to improving resource performance. An improvement of just one percent in conversion rate of a resource could double site revenue and reduce the cost per conversion/acquisition (CPA) associated with the marketing activities of the content provider.

Part of the challenge for content providers is the lack of a metric to identify/quantify the opportunity for the content provider. Content providers sometimes examine metrics such as time on site (e.g., an average time spent by users interacting with the resource), page load time (e.g., an average time it takes from the time a browser navigates to the resource until the time the resource loads in the browser), and/or bounce rate (e.g., an amount of users who visit the resource, leave without performing a converting activity, such as purchasing a product, and never return) as indicators of resource performance. However, such information often does not provide a good indication of the problems leading to reduced conversions, or an opportunity cost resulting from the problems. For instance, the content provider may not know whether there is a problem with a signup flow, product listings, support pages, etc. Further, the content provider may not know how much additional revenue/reduced cost may be gained by addressing the problems, and may not know whether the return associated with addressing the problems is worth the effort.

The systems and methods of the present disclosure may provide content providers with information regarding lost opportunities by focusing on data relating to one or more types of negative interactions reflected in path data. An analysis system may receive path data representing paths, each of which includes one or more interactions of a user with one or more resources. The system may identify one or more negative interactions in paths that may end in an interaction other than a conversion (e.g., an abandonment event, where the user navigates away from a resource and does not return). Each negative interaction may be or include one of one or more types of interactions that decrease a likelihood of a path including the negative interaction resulting in a conversion (e.g., a purchase of an item by a user). In some illustrative implementations, negative interactions may include inventory being out of stock, a signup form being abandoned (e.g., due to complexity of the signup form or a technical problem with the signup form), a broken link (e.g., leading to a 404 error), a slow page load time, etc. In some implementations, the types of interactions that are defined as negative interactions may be determined based on input from a content provider. In some implementations, the types of interactions that are defined as negative interactions may additionally or alternatively be determined based on analysis of path data, such as by identifying one or more types of interactions present in multiple paths that end in an interaction other than a conversion (e.g., an abandonment).

The system may be configured to analyze the negative interactions to infer whether the paths including the negative interactions likely would have resulted in conversions if not for the negative interactions. For each of the negative interactions, the system may determine an estimated probability that the path(s) including the negative interaction would have resulted in a conversion if the path(s) excluded the negative interaction. The system may determine the estimated probability based on a set of paths including common characteristics with the path(s) including the negative interaction. In one such implementation, if path(s) including a negative interaction included two interactions with paid content items prior to the negative interaction, the set of paths including the common characteristics may include interactions with two paid content items as well, but may or may not include the negative interaction. In some implementations, the system may determine the estimated probability based on a conversion rate associated with the set of paths that include the common characteristics but do not include the negative interaction. In some implementations, the system may determine the estimated probability based on a similarity level between a first set of characteristics associated with the path including the negative interaction and a second set of characteristics associated with the set of paths including the common characteristics. In some implementations, the set of paths including the common characteristics may be conversion paths ending in a conversion. In some implementations, the estimated probability may be a numerical value (e.g., number on a scale from 0-100).

The system may estimate an amount of lost revenue associated with one or more of the negative interactions based on the estimated probability. In some implementations, the system may estimate the lost revenue by determining a total amount of negative interactions likely to have resulted in conversion based on the estimated probability, and multiplying that amount by an expected revenue per conversion (e.g., an average revenue resulting from sales of one or more products featured in the paths including the negative interactions). In some implementations, the system may infer a lost revenue amount for one or more of the negative interactions by analyzing one or more interactions occurring after the negative interaction in the path and determining whether the subsequent interactions include an alternate purchase. For instance, if a user reaches a purchase page for a hotel in Paris on a first webpage, and there is no available inventory, the user may subsequently book a room at a different hotel in Paris. In such an implementation, the system may determine the lost revenue based on the difference in the revenue that would have been obtained from the original hotel versus the revenue obtained from the booking of the second hotel. If the second hotel is booked through another content provider, the system may determine the lost revenue based on the purchase price of the hotel booking with the other content provider (e.g., the purchase the first content provider lost due to lack of inventory). In some implementations, the system may determine an estimated additional amount of conversions and/or estimated new cost per conversion/acquisition (CPA) that would be expected to result if the negative interactions were removed from the paths, likely causing at least some of the paths to result in conversions. This may help provide a content provider with an idea of the value of addressing the negative interactions.

For situations in which the systems discussed herein collect and/or utilize personal information about users, or may make use of personal information, the users may be provided with an opportunity to control whether programs or features that may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

For situations in which the systems discussed herein collect and/or utilize information pertaining to one or more particular content providers, the content providers may be provided with an opportunity to choose whether to participate or not participate in the program/features collecting and/or utilizing the information. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

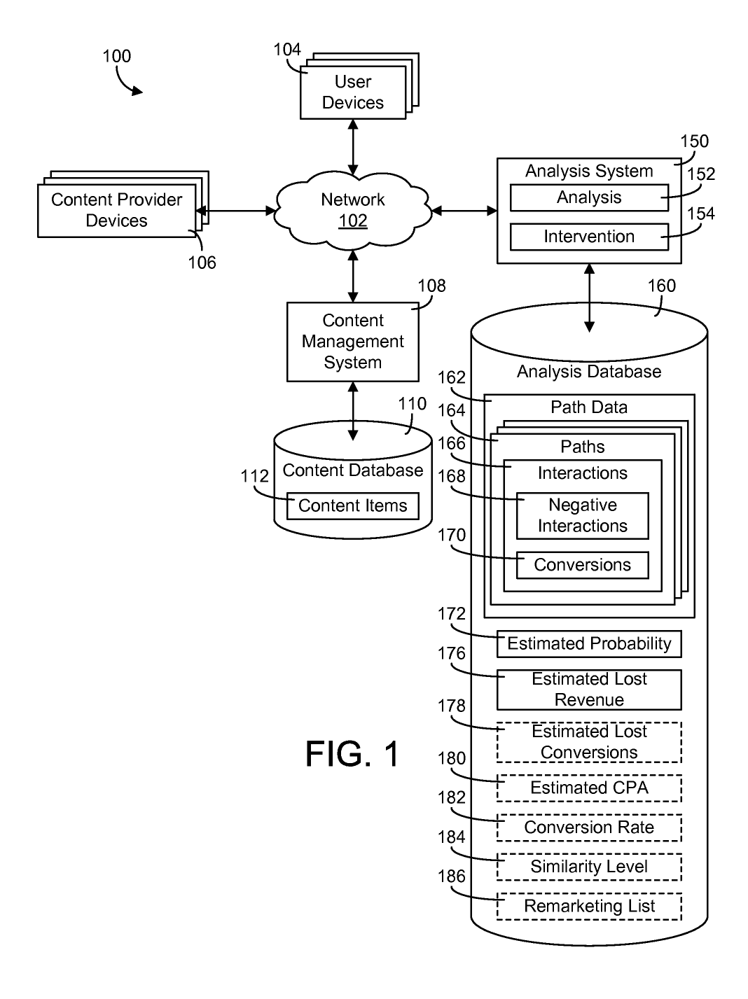

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

An analysis system 150 may be configured to analyze path data relating to interactions of one or more users of user devices 104 and infer an impact of one or more negative interactions reflected in the path data on revenue of a content provider. In some implementations, analysis system 150 may receive path data 162 that includes multiple paths 164. Each path 164 represents one or more interactions of a user with one or more resources (e.g., webpages, applications, etc.) and/or content items (e.g., paid and/or unpaid content items displayed within a resource, such as items displayed within a search engine results interface). System 150 may identify one or more negative interactions 168 within paths 164. Negative interactions 168 may be or include one or more types of interactions that reduce a likelihood of a user performing a conversion, such as a purchase of an item or provision of desired information to the content provider. In some implementations, negative interactions 168 may include interacting with a webpage offering an item for sale that is out of stock, being presented with a long or confusing form, experiencing a long resource load time, and/or other types of interactions. System 150 may be configured to determine a likelihood that the paths including negative interactions 168 would have resulted in conversion if not for negative interactions 168. Based on this determination, system 150 may estimate a lost revenue 176 due to negative interactions 168.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may be configured to analyze path data 162 relating to user interactions with one or more items, such as resources (e.g., webpages, applications, etc.) associated with a content provider and/or paid or unpaid content items displayed within an interface in a resource (e.g., a search engine interface), and estimate an impact of one or more negative interactions 168 reflected in path data 162. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. Analysis system 150 may include an analysis module 152 configured to analyze path data 162 and infer an impact of negative interactions 168 on revenue of a content provider. Analysis module 152 may identify negative interactions 168 within paths 164 of path data 162 (e.g., negative interactions within paths not resulting in a conversion 170, such as a purchase of a product). For each negative interaction 168, analysis module 152 may estimate a probability 172 that the path(s) including the negative interaction 168 would have resulted in a conversion if the path(s) excluded the negative interaction 168. Analysis module 152 may estimate an amount of lost revenue 176 associated with one or more of negative interactions 168 based on estimated probabilities 172 of the negative interactions 168.

In some implementations, analysis system 150 may include an intervention module 154 configured to implement one or more actions based on negative interactions 168. In some implementations, intervention module 154 may be configured to cause content management system 108 to lower a bid for displaying one or more content items when one or more paths 164 associated with the device to which the content items are to be presented include one or more of negative interactions 168. In some implementations, intervention module 154 may be configured to add one or more device identifiers associated with the paths including negative interactions 168 to a remarketing list 186. In some implementations, remarketing list 186 may be used to initiate additional marketing contacts with the listed devices. In one such implementation, devices may be added to remarketing list 186 in response to having been presented with sales pages for products that were out of stock, and remarketing list 186 may be used to market content items to the devices notifying the devices that the products are back in stock.

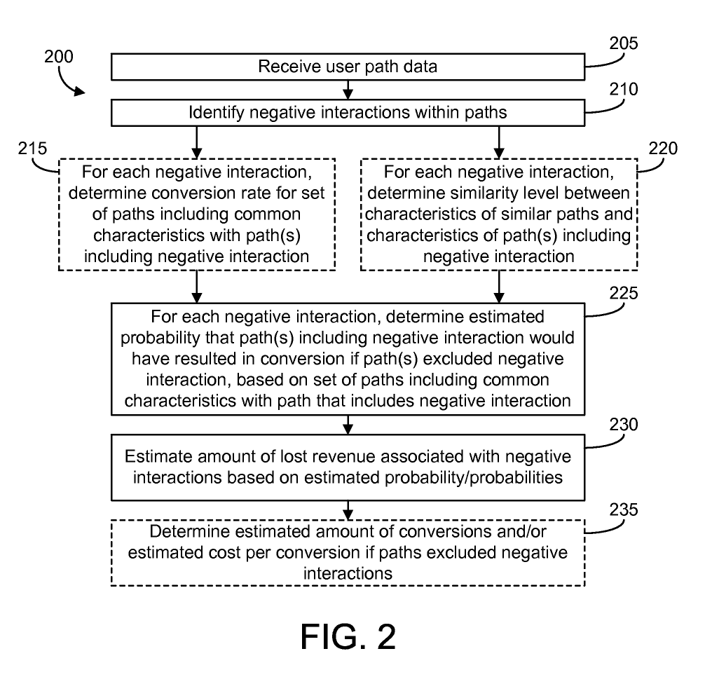

FIG. 2 illustrates a flow diagram of a process 200 for analyzing negative interactions in path data and estimating lost revenue due to the negative interactions according to an illustrative implementation. Referring to both FIGS. 1 and 2, analysis system 150 may be configured to receive path data 162 indicating one or more previous interactions of a user with one or more resources (e.g., webpages, applications, etc.) (205). In some implementations, some of the interactions may relate to content items provided within a resource (e.g., within a content interface). The content items may include paid content items (e.g., paid items displayed within a search engine results interface and/or a different webpage, such as through the use of an auction process) and/or unpaid content items (e.g., unpaid search results displayed within a search engine results interface, unpaid links within a webpage, etc.). The content campaign may include one or more content items that the content provider wishes to have presented to user devices 104 by content management system 108. In some implementations, some of the content items may have one or more products and/or services associated with the content item. In some implementations, such content items may be designed to promote one or more particular products and/or services. In some implementations, some content items may be configured to promote the content provider, an affiliate of the content provider, a resource (e.g., website) of the content provider, etc. in general, and the products and/or services associated with the content item may be any products and/or services offered for sale through the content provider, affiliate, resource, etc. In some implementations, some content items may be configured to direct user devices 104 to resources configured to request information from a user, such as a lead form provided on a webpage.

Path data 162 may include any type of data from which information about previous interactions of a user with resources and/or content presented therein can be determined. The interactions may be instances where impressions of a campaign content item have been displayed on the user device of the user, instances where the user clicked through or otherwise selected the content item, instances where the user converted (e.g., purchased a product/service as a direct or indirect result of an interaction with a campaign content item), etc.

In some implementations, path data 162 may include resource visitation data collected by analysis system 150 describing some or all activities leading to a website or other resource of the content provider. Analysis system 150 may collect information relating to a portion of the resource visited/accessed, an identifier associated with the user device that accessed the resource, information relating to an origin or previous location that the user/device last visited before accessing the resource, information relating to a trigger that caused the user device (e.g., device browser application) to navigate to the resource (e.g., the user manually accessing the resource, such as by typing a URL in an address bar, a link associated with a content item selected on the user device causing the user device to navigate to the resource, etc.), and/or other information relating to the user interaction with the resource. In some implementations, path data 162 may include one or more keywords associated with content items through which the resource was accessed.

In some implementations, path data 162 may include result data associated with a resource visit or other user interaction with one or more content items of the content campaign. The result data may indicate whether the visit resulted in the purchase of one or more products or services, an identity of any products/services purchased, a value of any purchased products/services, etc. In some implementations, path data 162 may be configured to follow a path from a first user visit to the resource and/or interaction with a content item of the content campaign to one or more conversions resulting from visits/interactions. The full path from a first user interaction to a converting action, such as a purchase or provision of information requested by a content provider, may be referred to as a converting path. In some implementations, path data 162 may include data relating to multiple conversion paths 164.

In various implementations, path data 162 may reflect one or more of a variety of different types of user interactions. In some illustrative implementations, the interactions may include viewing a content item impression, clicking on or otherwise selecting a content item impression, viewing a video, listening to an audio sample, viewing a webpage or other resource, and/or any other type of engagement with a resource and/or content item displayed thereon. In some implementations, the interactions may include any sort of user interaction with content without regard to whether the interaction results in a visit to a resource, such as a webpage, associated with the content provider.

In various implementations, a device identifier may be a browser cookie, a unique device identifier (e.g., a serial number), a device fingerprint (e.g., collection of non-private characteristics of the user device), or another type of identifier. The identifier may not include personally identifiable data from which an actual identity of the user can be discerned. Analysis system 150 may be configured to require consent from the user to tie an identifier to path data 162. In some implementations, path data from multiple sources may be utilized even if the path data sets reference different types of identifiers. For example, user paths may be joined by matching one identifier (e.g., browser cookie) with another identifier (e.g., a device identifier) to associate both path data sets as corresponding to a single user.

In some circumstances, path data 162 may include paths that appear to end prior to a conversion, but which are actually continued in other paths. In some implementations, analysis system 150 may be configured to determine whether any non-converting paths in path data 162 are actually continued in other user paths, and are not in fact non-converting paths. In some instances, some user paths may be incorrectly interpreted as non-converting paths ending in abandonment events. In some implementations, a user may complete one or more interactions on a first device, such as a mobile device, then move to a second device (e.g., a desktop or laptop computer) to complete additional interactions, the last of which may be a conversion action (e.g., a product purchase). In such implementations, path data 162 may not connect the interactions on the first device with those on the second device, and system 150 may improperly interpret the last interaction on the first device as an abandonment.

In some implementations, system 150 may be configured to detect false positive abandonment events within path data 162 and connect the related paths to form more accurate, complete conversion paths for use in analyzing negative interactions 168. System 150 may determine one or more false positive abandonment events within path data 162. In some implementations, system 150 may utilize an identifier or other signal associated with a path indicating that the user interactions associated with the path are continued on another path associated with another device. Based on the data, system 150 may determine whether a path that appears to be a non-converting path includes a false positive abandonment event, such that the user interactions were continued as reflected in another path associated with another device. System 150 may then merge the two partial paths to determine the full conversion path prior to analyzing negative interactions 168 based on the path.

Analysis system 150 may be configured to identify one or more negative interactions 168 within paths 164 of path data 162 (210). Negative interactions 168 are each one of one or more types of interactions that can decrease a likelihood of the path including the interaction resulting in a conversion. In various implementations, negative interactions 168 may include being presented with a sales offer for an item that is out of stock, interacting with a long or confusing signup form that results in the user navigating away from the form before completion, clicking a broken link (e.g., being presented with a 404 error page), experiencing a long page load time, being presented with a content item that creates an expectation of a special offer and being linked to an offer page that does not fulfill the expectation generated by the content item, and/or any other type of interaction that might decrease the probability that the user will perform a conversion. In one illustrative travel-related implementation, negative interactions 168 may include an interaction in which a user is presented with an offer to purchase a discounted hotel room, but the hotel is out of inventory for the dates desired by the user. In response, the user may purchase a hotel room at another hotel or in another geographic location. In some implementations, negative interactions 168 may include presentation of a user with a website copy or display creative that makes a promise (e.g., “Click here to view an amazing offer!”) that leads to disappointment and abandonment. Each negative interaction 168 may be present in one or more of paths 164 within path data 162. In some implementations, negative interactions 168 may be identified within paths 164 based on tags placed within the resource, such as through a tag management product or through tags integrated directly into foundational processes, such as a shopping cart engine.

In some implementations, negative interactions 168 may include interactions with content items presented to users marketing a content provider and/or the brands, products/services, website, etc. of the content provider. In one such implementation, a content item promising the lowest prices on a flight to Paris may be presented to a user, and the user may be disappointed when prices offered on a webpage to which the content item links are found to be at market rate. In some implementations, the content provider may address such negative interactions by changing the text of the content item to avoid making a claim of having the lowest prices. In some implementations, the content provider may adjust the offered prices so that they are lower than market rate.

In some implementations, negative interactions 168 may be defined based on input received from a content provider. In some such implementations, the content provider may provide input specifying one or more types of interactions the content provider believes to be adversely impacting the conversion rate of the content provider. Analysis system 150 may define the negative interactions 168 to be analyzed based on the input from the content provider.

In some implementations, system 150 may be configured to determine one or more negative interactions 168 based on analysis of path data 162 (e.g., using machine learning). In some such implementations, system 150 may identify one or more non-converting paths, or paths ending in an interaction other than a conversion 170. System 150 may analyze the non-converting paths to determine one or more types of interactions common to several of the non-converting paths. In some implementations, system 150 may be configured to infer that a particular type of interaction or set of interactions (e.g., a type of interaction having a particular characteristic) are negative interactions when the interactions appear in at least a predetermined number and/or percentage of the non-converting paths.

In some implementations, system 150 may test whether one or more candidate type of interaction is a negative interaction based on a first set of paths including the tested interaction and one or more second sets of paths not including the tested interaction. In one such implementation, system 150 may determine a first conversion rate associated with the first set of paths including the tested interaction and a second conversion rate associated with a second set of paths including similar interactions as the first set of paths, but not including the tested interaction. If the second conversion rate is substantially lower than the first conversion rate (e.g., if the difference between the first conversion rate and the second conversion rate is greater than a threshold difference), analysis system 150 may determine that the tested type of interaction is a negative interaction, and may define a negative interaction 168 based on the tested interaction. In some implementations, system 150 may be configured to test multiple sets of paths to eliminate other variables and determine that a particular interaction is a negative interaction. In one such implementation, system 150 may test a particular landing page to determine whether interactions with the landing page are negative interactions by analyzing conversion rates associated with other variables, such as the source resource leading to the landing page (e.g., search engine page or other webpage), a type of content item through which the device linked to the landing page, one or more keywords triggering display of the content item, and/or other variables, while holding the landing page constant. If the conversion rates are fairly constant when varying the other variables, but drop significantly when the landing page is the tested landing page (as compared to one or more other tested landing pages in paths not including the landing page), system 150 may infer that the tested landing page is associated with negative interactions. System 150 may subsequently define negative interactions 168 as including interactions with the tested landing page.

System 150 may be configured to estimate a probability 174 for each of negative interactions 168 that the one or more paths including the negative interaction 168 would have resulted in a conversion if not for the negative interaction 168. For each instance of negative interaction 168, a device identifier of a device associated with the negative interaction 168 may be stored, and the event may be recorded. System 150 may compare the current behavior associated with the device identifier to a model of other similar, converting customers to determine a probability that the user associated with the device identifier would have converted if the user did not encounter the negative interaction 168. In some implementations, system 150 may analyze one or more subsequent interactions of the device identifier after the negative interaction 168 (e.g., in a range set by similar, previous paths) to observe whether an alternate purchase is made, which may help improve the model's predictions and the accuracy of the resulting metrics. In some implementations, system 150 may estimate probability 174 based on a conversion rate 182 of paths including common characteristics with the paths including the negative interaction 168. For each negative interaction 168, system 150 may determine a conversion rate for a set of paths including one or more common characteristics with the paths including the negative interaction 168 (215). In some implementations, system 150 may identify the set of paths with common characteristics by selecting a set of paths from among paths 164 of path data 162 that include a threshold number or percentage of characteristics and/or interactions that are similar to those of the paths including the negative interaction 168. In one such implementation, system 150 may select a set of paths where at least 50 percent of the interactions in the path are the same type of interaction, or analogous interactions, to corresponding interactions included in the paths with the negative interaction 168. In another such implementation, system 150 may select a set of paths where one or more interactions immediately before and/or after the negative interaction 168 are included within the paths. In some implementations, the selected paths may include the common characteristics/interactions, but may not include the negative interaction 168. System 150 may determine a conversion rate 182 based on the selected paths (e.g., a number and/or percentage of the selected paths ending in a conversion 170).

In some implementations, system 150 may estimate probability 174 for each negative interaction 168 based on a level of similarity between the paths including the negative interaction 168 and a set of similar paths. For each negative interaction 168, system 150 may determine a similarity level 184 between characteristics of the paths including the negative interaction 168 and a set of similar paths (220). In some implementations, the set of similar paths may include one or more similar characteristics/interactions to the paths including the negative interaction 168, but may not include the negative interaction 168. In some implementations, the set of similar paths may include conversion paths resulting in conversions 170. In some implementations, system 150 may determine similarity level 184 based on a number or percentage of conversion paths in path data 162 including one or more particular characteristics (e.g., types of interactions) in common with the paths including the negative interaction 168. In some implementations, system 150 may determine similarity level 184 based on an amount (e.g., normalized percentage) of characteristics the paths including the negative interaction 168 have in common with a set of conversion paths including one or more common characteristics.

For each negative interaction 168, system 150 may be configured to determine an estimated probability 172 that the paths including the negative interaction 168 would have resulted in a conversion if the paths excluded the negative interaction 168 (225). System 150 may determine estimated probability 172 based on at least one set of one or more paths including one or more common characteristics with the paths including the negative interaction.

In some implementations (e.g., implementations including operation 215), system 150 may determine estimated probability 172 based on a conversion rate for the set of similar paths including the common characteristics. In one such implementation, if a set of similar paths including common characteristics but excluding the negative interaction 168 has a conversion rate of two percent, system 150 may infer that two percent of the paths including the negative interaction 168 would have resulted in conversions if not for the negative interaction 168 (e.g., if 1000 paths included the negative interaction 168, 20 paths likely would have resulted in conversions).

In some implementations, system 150 may determine estimated probability 172 based on similarity level 184. In one such implementation, system 150 may determine similarity level 184 based on a set of conversion paths, and system 150 may determine estimated probability 172 based on a value of similarity level 184. For instance, if similarity level 184 is a first high level (e.g., 90 percent similarity between the conversion paths and the paths including the negative interaction 168), system 150 may determine estimated probability 172 to be a first high value, and if similarity level 184 is a second lower level (e.g., 20 percent similarity), system 150 may determine estimated probability 172 to be a second lower value.

In some implementations, system 150 may determine estimated probability 172 based on a combination of conversion rate 182 and similarity level 184. In some such implementations, system 150 may estimate probability 172 based on conversion rate 182, and may adjust estimated probability 172 based on similarity level 184. In one such implementation, if conversion rate 182 for a set of similar paths having common characteristics is five percent, but similarity level 184 is only twenty percent (e.g., indicating the paths including the negative interaction 168 and the similar paths include a substantial amount of different characteristics, such as types of interactions), system 150 may conservatively estimate probability 172 as less than a five percent chance that the paths would have included conversions but for the negative interaction 168 (e.g., four percent).

System 150 may estimate an amount of lost revenue 176 associated with one or more of negative interactions 168 (230). In some implementations, system 150 may estimate an amount of paths including a particular negative interaction 168 that would likely have resulted in conversions by determining a total number of paths including the negative interaction 168 within path data 162 associated with a content provider and multiplying the total number by the estimated probability 172. System 150 may multiply the estimated amount of paths including the negative interaction 168 that likely would have resulted in conversions by an estimated revenue associated with each conversion to determine lost revenue 176. In some implementations, the estimated revenue associated with each conversion may be an average revenue associated with items offered for sale within paths 164, an estimated revenue value provided by the content provider, etc. In some implementations, system 150 may be configured to determine lost revenue 176 for one or more individual instances of negative interactions 168. In some such implementations, system 150 may determine lost revenue 176 based on a revenue associated with the sale of one or more products that were or would have been offered for sale within the paths including the negative interaction 168 that likely would have resulted in conversion but for the negative interaction 168. System 150 may total the revenue values associated with the individual instances to determine lost revenue 176 for all instances of the negative interaction 168. In some implementations, system 150 may determine lost revenue 176 for multiple negative interactions 168. In some such implementations, system 150 may determine a revenue associated with each of multiple negative interactions 168, and may total the determined revenue values to determine lost revenue 176.

In some implementations, system 150 may estimate an amount of lost revenue 176 for one or more of negative interactions 168 based in part on one or more interactions occurring after instances of negative interactions 168 within paths 164. In some such implementations, system 150 may determine one or more interactions associated with revenue, such as sales interactions in which an item is purchased by a user, occurring after instances of negative interactions 168. For instance, a user may be presented with an offer to purchase a hotel room, but the hotel room may be out of stock for the dates in which the user is interested. Instead, the user may purchase a room at a different hotel. In such an implementation, system 150 may estimate a lost revenue associated with the out-of-stock interaction based on the purchase price of the other hotel room (e.g., based on the assumption that the user would have been willing to spend a similar amount of money on the first hotel room). In some implementations, system 150 may determine lost revenue 176 based in part on a combination of the revenue values for the instances of the negative interaction 168 estimated based in part on the purchase prices of the alternative purchases.

In some implementations, system 150 may be configured to take into account future potential lost business when estimating lost revenue 176. When a user experiences a negative interaction 168, it may impact not only the likelihood that the user will perform a conversion in relation to the path including the negative interaction 168, but also the likelihood that the user will continue to be a customer of the content provider. For instance, if an item is out of stock, the user may turn to another provider to purchase the item, and thereafter may return to the other provider to purchase future items rather than returning to the content provider. Thus, in some implementations, negative interactions 168 may impact new customer acquisition and current customer retention, as well as incremental purchases. In some implementations, system 150 may be configured to determine a customer lifetime value (CLV) for one or more paths including negative interactions 168, and may determine estimated lost revenue 176 based in part on the CLV value. In one such implementation, system 150 may receive a CLV value from the content provider (e.g., an estimated average lifetime value of a customer of the content provider). System 150 may estimate that a particular percentage (e.g., two percent) of the users experiencing a particular negative interaction 168 may not return. In such an implementation, system 150 may estimate lost revenue 176 based in part on the lost incremental conversions associated with the users who experienced the negative interaction 168, and may also include the CLV value in lost revenue 176 for the percentage of users system 150 estimates will discontinue business with the content provider.

In some implementations, system 150 may determine an estimated amount of lost conversions 178 and/or an estimated cost per conversion (e.g., CPA) if paths 164 excluded one or more of negative interactions 168 (235). In some such implementations, system 150 may determine an estimated amount of lost conversions 178 due to a particular negative interaction 168 based on estimated probability 172 for the negative interaction 168 and a total amount of instances of the negative interaction 168 occurring in paths 164 associated with a content provider. For instance, system 150 may multiply probability 172 (e.g., indicating an estimated percentage of paths including the negative interaction 168 that would have resulted in conversion if not for the negative interaction 168) by the total number of instances to determine estimated lost conversions 178. In some implementations, system 150 may determine an estimated cost per conversion 180 (e.g., CPA) if paths 164 excluded a particular negative interaction 168. In some such implementations, system 150 may offset a marketing cost value used to determine the cost per conversion by estimated lost revenue 176 to determine a new net cost value for use in determining estimated cost per conversion 180. In some implementations, system 150 may add estimated lost conversions 178 to the actual conversions and divide the marketing cost value by the new estimated number of total conversion to determine estimated cost per conversion 180. In some implementations, estimated cost per conversion 180 may be substantially lower than the actual cost per conversion with negative interactions 168.

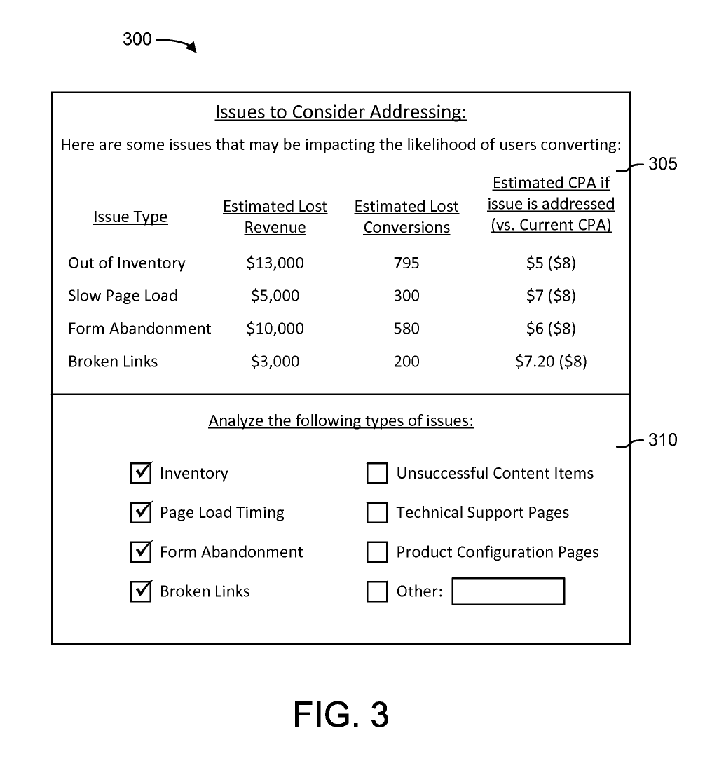

Referring now to FIG. 3, an illustration of a user interface 300 that may be used to provide information relating to the impact of one or more negative interactions is shown according to an illustrative implementation. Interface 300 includes a data portion 305 configured to provide a content provider with one or more items of information relating to the impact of one or more types of negative interactions. Data portion 305 may provide information such as a type of negative interaction, an estimated lost revenue due to the type of negative interaction, an estimated number of lost conversions due to the type of negative interaction, an estimated cost per conversion if the issue is addressed, and/or other types of information. In the illustrated implementation, data portion 305 includes data showing an impact of four different types of negative interactions: users being presented with a sales offer page for an item that is out of inventory, users being presented with a page that loads slowly, users being presented with forms that they abandon before submitting the form information, and users clicking through broken links (e.g., and being presented with a 404 page error). The content provider may use the provided information to determine a potential benefit associated with addressing each of the types of negative interactions. In some implementations, data portion 305 may also show information relating to a total impact if all the types of negative interactions were addressed.

In some implementations, interface 300 may include a configuration portion 310. Configuration portion 310 may allow the content provider to provide input specifying the types of negative interactions to be analyzed. In the illustrated implementation, the content provider has opted to analyze negative interactions pertaining to inventory issues, page load timing, form abandonment, and broken links. The content provider has opted not to analyze issues relating to unsuccessful content items (e.g., content items associated with a low conversion rate), technical support pages (e.g., confusing technical support pages leading to unanswered questions and abandonment), and product configuration pages (e.g., issues with product configuration interfaces causing users to abandon the product configuration prior to purchasing the product). In some implementations, configuration portion 310 may allow the content provider to specify one or more additional types of negative interactions to be analyzed in an “other” field.

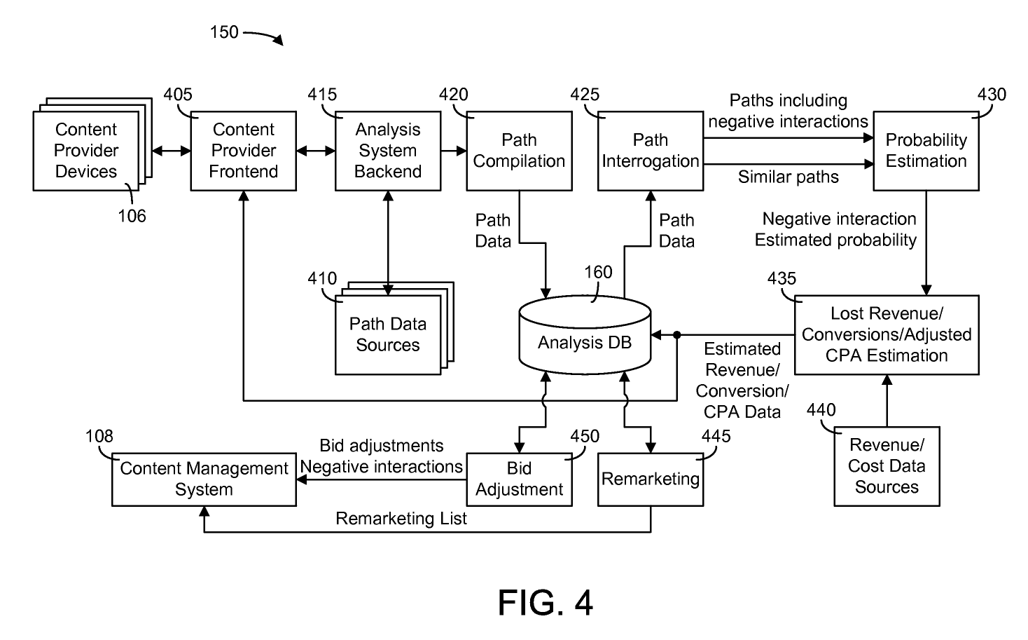

Referring now to FIG. 4, one detailed illustrative implementation of analysis system 150 is provided. In the illustrated implementation, system 150 includes a content provider frontend 405, an analysis system backend 415, a path compilation module 420, a path interrogation module 425, a probability estimation module 430, and an impact estimation module 435. In some implementations, system 150 may include a bid adjustment module 450 and/or remarketing module 445. It should be understood that the detailed implementation of analysis system 150 shown in FIG. 4 is provided for purposes of illustration, and in other implementations, analysis system 150 may include additional, fewer, and/or different components. Further, each of the illustrated systems and/or components may be implemented as a separate computing system, multiple systems may be combined within a single hardware system, and/or one or more systems or components may be implemented in a cloud, or distributed computing, environment.

Content provider devices 106 may provide information to and/or receive information from analysis system 150 via a content provider frontend 405. Content provider frontend 405 may provide an interface through which content providers can provide data, modify settings or parameters used by analysis system 150, receive information from analysis system 150, etc. In some implementations, content provider frontend 405 may be or include a web-based user interface (e.g., implemented via a web-based programming language such as HTML, Javascript, etc.). In some implementations, content provider frontend 405 may include a custom API specific to a particular content provider. In some implementations, content provider frontend 405 may allow content providers to upload data sets individually and/or in batches.

Content provider frontend 405 may transmit data to and receive data from an analysis system backend 415. Analysis system backend 415 may be configured to retrieve data and/or generate commands needed to perform various functions of analysis system 150. In some implementations, analysis system backend 415 may implement the various functions by transmitting commands to various modules configured to carry out particular functions or sets of functions.

Analysis system backend 415 may collect data relating to user interactions with resources from one or more path data sources 410. Path data sources 410 may be any type of data sources that provide information pertaining to interactions of users with resources and/or content items presented therein. In some implementations, path data sources 410 may be received from content management system 108 (e.g., data regarding interactions of user devices 104 with one or more content items served by content management system 108), a search engine server (e.g., data regarding interactions of user devices 104 with search engine results, queries submitted by user devices 104, links clicked through by user devices 104, etc.), servers providing one or more online services (e.g., location-based services, such as a mapping service, media services, such as an online video and/or photo service, social media services, such as an online social network, etc.), and/or other types of sources. In some implementations, analysis system backend 415 may transmit request messages to path data sources 410 for interaction data, and, in response, path data sources 410 may transmit messages to analysis system backend 415 including the interaction data. In some implementations, the response messages may include one or more identifiers (e.g., device identifiers) that may be used to identify a user device 104 associated with the interaction data and/or one or more pieces of timestamp data used to identify when the interactions occurred.

Analysis system backend 415 may transmit the interaction data to a path compilation module 420. Path compilation module 420 may construct path data 162 including paths 164 based on the interaction data. In some implementations, the interaction data may include disparate interaction data that is not correlated when received by analysis system backend 415, and path compilation module 420 may utilize the identifiers associated with the interaction data to identify which interactions are associated with each user device 104. Path compilation module 420 may utilize the timestamp data and identifiers to build paths 164 for the different user devices 104. The resultant path data 162 may be stored in analysis database 160.

Path interrogation module 425 may be configured to retrieve path data 162 from analysis database 160 and determine negative interactions 168 within paths 164 (e.g., operation 210 of process 200). Path interrogation module 425 may provide data relating to the paths including the determined negative interactions 168 to a probability estimation module 430. In some implementations, path interrogation module 425 may also be configured to analyze paths 164 to identify a set of one or more paths having characteristics (e.g., types of interactions) similar to those of the paths including negative interactions 168. In such implementations, path interrogation module 425 may also provide data relating to the similar paths to probability estimation module 430.

Probability estimation module 430 may be configured to generate estimated probability 172 for each negative interaction 168 that the paths including the negative interaction 168 would result in conversions if not for the negative interaction 168 (e.g., operation 225 of process 200). In some implementations, probability estimation module 430 may determine conversion rate 182 and/or similarity level 184 for the set of similar paths (e.g., operations 215 and 220, respectively, of process 200), and may utilize one or both of these metrics to determine estimated probability 172 for each negative interaction 168. Probability estimation module 430 may transmit data representative of estimated probability 172 for each negative interaction 168 to be analyzed to impact estimation module 435.

Impact estimation module 435 may estimate lost revenue 176, lost conversions 178, and/or an adjusted cost per conversion 180 based on the received estimated probability 172 (e.g., operations 230 and/or 235 or process 200). In some implementations, impact estimation module 435 may receive revenue and/or cost data from one or more revenue/cost data sources 440. In some such implementations, impact estimation module 435 may receive revenue data associated with one or more types of interactions and/or paths (e.g., for use in generating estimated lost revenue 176), cost data associated with one or more paid content items presented to users on behalf of the content provider (e.g., for use in estimating adjusted cost per conversion 180), and/or other types of data. Impact estimation module 435 may store the generated impact data in analysis database 160. In some implementations, impact estimation module 435 may additionally or alternatively provide the generated impact data to content provider frontend 405, which may allow content provider devices 106 to access part or all of the impact data through a user interface presented by content provider frontend 405 on content provider devices 106.

In some implementations, analysis system 150 may include a bid adjustment module 450 configured to retrieve data relating to one or more of negative interactions 168 from analysis database 160 and generate commands configured to cause content management system 108 to adjust one or more bids for presenting content items to user devices. In some such implementations, bid adjustment module 450 may determine whether a particular negative interaction 168 is likely to cause users not to perform a desired conversion. For instance, bid adjustment module 450 may determine whether lost revenue 176, lost conversions 178, and/or another value indicative of an impact of a particular negative interaction 168 is above a threshold value. If so, bid adjustment module 450 may transmit a command message to content management system 108 configured to cause content management system 108 to lower bids by a specified value (e.g., based on a bid multiplier provided in the command message) when path data 162 for the user device to which the content item is to be directed includes the negative interaction 168. In some implementations, the bid multiplier may be determined based in part on a value of lost revenue 176, lost conversions 178, and/or another indicator of impact (e.g., such that the bid is lowered by a greater amount when the negative interactions 168 has a greater likelihood of causing a user not to convert).

In some implementations, analysis system 150 may include a remarketing module 445 configured to retrieve data relating to one or more of negative interactions 168 and generate a remarketing list 186 based on the data. In some such implementations, analysis system 150 may be configured to identify device identifiers associated with paths including a particular negative interaction 168 and add the device identifiers to remarketing list 186. Remarketing list 186 may be used to direct marketing content to the user devices 104 associated with the device identifiers in an attempt to encourage the users of the user devices 104 to perform a conversion. In some implementations, remarketing list 186 may be used to notify the user devices 104 when a problem associated with the negative interactions 168 has been addressed. For instance, a remarketing list 186 may be generated including identifiers of user devices 104 who were presented with an offer to purchase an item that was out of stock, and remarketing list 186 may be used to direct communications (e.g., emails, content items, etc.) to the user devices 104 to notify the users that the product is back in stock. In some implementations, remarketing list 186 may be transmitted to content management system 108, and content management system 108 may be configured to increase one or more bids for content items to be presented to user devices 104 associated with the identifiers in remarketing list 186.

In some implementations, system 150 (e.g., bid adjustment module 450 and/or remarketing module 445) may be configured to utilize conditional feedback before recommending and/or implementing actions based on negative interactions 168. For instance, system 150 may be configured to generate a report indicating that $X were lost due to unavailable inventory, resulting in bid changes by $Y. However, the inventory condition may have been resolved by the time the report was received, and the bid changes may have been in response to a condition that no longer existed. In some implementations, system 150 may be configured to compare the conditions that triggered negative interactions 168 (e.g., out-of-inventory events) to current conditions prior to generating a report, changing a bid, adding a device identifier to remarketing list 186, etc. before taking action. In one such implementation, if the condition no longer exists, the report may still be generated to show the historical impact of the inventory event on marketing performance, but may provide an indication that the out-of-inventory event has been addressed, so that the content provider reviewing the report does not feel compelled to adjust bids for a situation that no longer exists.

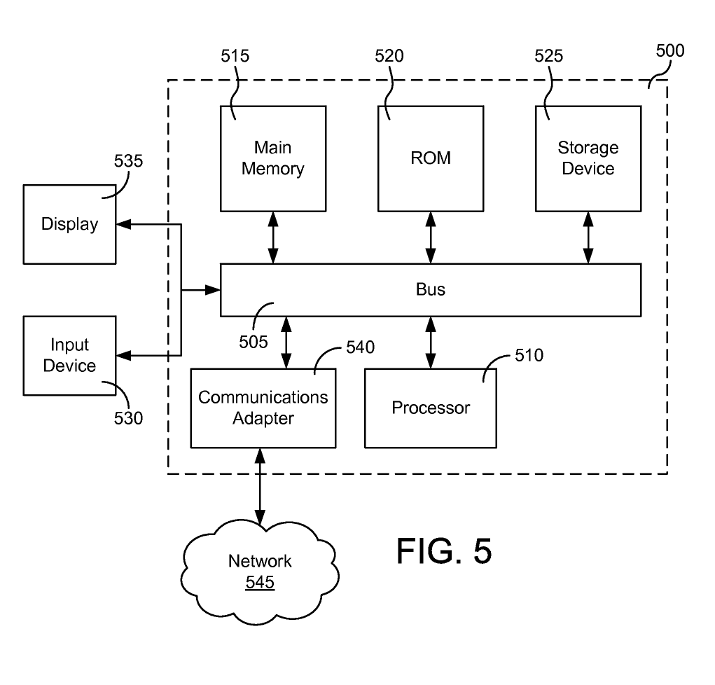

FIG. 5 illustrates a depiction of a computer system 500 that can be used, for example, to implement an illustrative user device 104, an illustrative content management system 108, an illustrative content provider device 106, an illustrative analysis system 150, and/or various other illustrative systems described in the present disclosure. The computing system 500 includes a bus 505 or other communication component for communicating information and a processor 510 coupled to the bus 505 for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information, and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

In some implementations, the computing system 500 may include a communications adapter 540, such as a networking adapter. Communications adapter 540 may be coupled to bus 505 and may be configured to enable communications with a computing or communications network 545 and/or other computing systems. In various illustrative implementations, any type of networking configuration may be achieved using communications adapter 540, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a computerized analysis system, path data representing a plurality of paths, each path comprising one or more interactions of a user with one or more resources;
identifying, by the analysis system, one or more negative interactions within one or more of the plurality of paths ending in an interaction other than a conversion, each negative interaction comprising one of one or more types of interactions that decrease a likelihood of a path resulting in a conversion, and each negative interaction being included within one or more of the plurality of paths;
for each of the one or more negative interactions, determining, by the analysis system, an estimated probability that the one or more paths including the negative interaction would have resulted in a conversion if the one or more paths excluded the negative interaction based on a first set of two or more of the plurality of paths including one or more common characteristics with the one or more paths including the negative interaction; and
estimating an amount of lost revenue associated with one or more of the negative interactions based on the estimated probability.

2. The method of claim 1, wherein, for each of the one or more negative interactions, the two or more paths of the first set of paths each include the one or more common characteristics with the one or more paths including the negative interaction and exclude the negative interaction.

3. The method of claim 2, further comprising, for each of the one or more negative interactions, determining, for the first set of paths, a conversion rate representative of an amount of paths in the first set of paths resulting in a conversion, wherein the estimated probability for each of the one or more negative interactions is determined based on the conversion rate.

4. The method of claim 2, further comprising, for each of the one or more negative interactions, determining a similarity level between a first set of one or more characteristics associated with the one or more paths including the negative interaction and a second set of one or more characteristics associated with the first set of paths, wherein the estimated probability for each of the one or more negative interactions is determined based on the similarity level.

5. The method of claim 1, wherein the amount of lost revenue is estimated based in part on one or more interactions occurring after the negative interactions in one or more of the paths including the negative interactions.

6. The method of claim 5, wherein the amount of lost revenue is estimated based in part on one or more item purchases associated with the one or more interactions occurring after the negative interactions, the amount of lost revenue being estimated based in part on one or more purchase prices of the one or more item purchases.

7. The method of claim 1, further comprising determining at least one of an estimated amount of conversions or an estimated cost per conversion if the plurality of paths excluded one or more of the negative interactions based on the estimated probability.

8. The method of claim 1, wherein the one or more negative interactions comprise at least one of a technical problem with at least one of the one or more resources or a lack of available inventory of an item offered for sale.

9. The method of claim 1, further comprising defining the one or more types of interactions based on input from a content provider.

10. The method of claim 1, further comprising defining the one or more types of interactions by analyzing the path data and determining one or more characteristics present in a plurality of the paths ending in an interaction other than a conversion.

11. The method of claim 1, wherein one or more of the plurality of paths are associated with a first device, and wherein the method further comprises causing a content management system configured to conduct auctions to display content items to users to lower a bid to display a first content item to the first device when the one or more paths associated with the device include one or more of the negative interactions.

12. The method of claim 1, wherein each of the plurality of paths is associated with one of a plurality of device identifiers, and wherein the method further comprises adding one or more of the device identifiers associated with the paths including the negative interactions to a remarketing list.

13. A system comprising:
at least one computing device operably coupled to at least one memory and configured to:
receive path data representing a plurality of paths, each path comprising one or more interactions of a user with one or more resources;
identify one or more negative interactions within one or more of the plurality of paths ending in an interaction other than a conversion, each negative interaction comprising one of one or more types of interactions that decrease a likelihood of a path resulting in a conversion, and each negative interaction being included within one or more of the plurality of paths;
for each of the one or more negative interactions, determine an estimated probability that the one or more paths including the negative interaction would have resulted in a conversion if the one or more paths excluded the negative interaction based on a first set of two or more of the plurality of paths including one or more common characteristics with the path including the negative interaction; and
estimate an amount of lost revenue associated with one or more of the negative interactions based on the estimated probability.

14. The system of claim 13, wherein, for each of the one or more negative interactions, the at least one computing device is further configured to determine, for the first set of paths, a conversion rate representative of an amount of paths in the first set of paths resulting in a conversion, wherein the estimated probability for each of the one or more negative interactions is determined based on the conversion rate.

15. The system of claim 13, wherein, for each of the one or more negative interactions, the at least one computing device is further configured to determine a similarity level between a first set of one or more characteristics associated with the one or more paths including the negative interaction and a second set of one or more characteristics associated with the first set of paths, wherein the estimated probability for each of the one or more negative interactions is determined based on the similarity level.

16. The system of claim 13, wherein the at least one computing device is further configured to determine at least one of an estimated amount of conversions or an estimated cost per conversion if the plurality of paths excluded the one or more negative interactions based on the estimated probability.

17. The system of claim 13, wherein the at least one computing device is further configured to determine the one or more types of interactions by analyzing the path data and determining one or more characteristics present in a plurality of the paths ending in an interaction other than a conversion.

18. One or more computer-readable storage media having instructions stored thereon that, when executed by at least one processor, cause the at least one processor to perform operations comprising:
receiving path data representing a plurality of paths, each path comprising one or more interactions of a user with one or more resources;
identifying one or more negative interactions within one or more of the plurality of paths ending in an interaction other than a conversion, each negative interaction comprising one of one or more types of interactions that decrease a likelihood of a path resulting in a conversion, and each negative interaction being included within one or more of the plurality of paths;
for each of the one or more negative interactions, determining an estimated probability that the one or more paths including the negative interaction would have resulted in a conversion if the one or more paths excluded the negative interaction based on a first set of two or more of the plurality of paths including one or more common characteristics with the path including the negative interaction;
estimating an amount of lost revenue associated with one or more of the negative interactions based on the negative interactions for which the estimated probability exceeds the threshold probability; and
determining at least one of an estimated amount of conversions or an estimated cost per conversion if the plurality of paths excluded the one or more of the negative interactions based on the estimated probability.

19. The one or more computer-readable storage media of claim 18, the operations further comprising, for each of the one or more negative interactions, determining, for the first set of paths, a conversion rate representative of an amount of paths in the first set of paths resulting in a conversion, wherein the estimated probability for each of the one or more negative interactions is determined based on the conversion rate.

20. The one or more computer-readable storage media of claim 18, the operations further comprising determining a similarity level between a first set of one or more characteristics associated with the one or more paths including the negative interaction and a second set of one or more characteristics associated with the first set of paths, wherein the estimated probability for each of the one or more negative interactions is determined based on the similarity level.
